(19) United States
(12) Patent Application Publication
(10) Pub. No.: US 2007/0064937 A1
(43) Pub. Date: Mar. 22, 2007

(54) Method and apparatus for encoding or decoding a bitstream

(76) Inventors: Adriaan Johan Van Leest, Eindhoven (NL); Minne Van Der Veen, Eindhoven (NL); Alphons Antonius Maria Lambertus Bruekers, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/580,503

(22) PCT Filed: Nov. 23, 2004
(86) PCT No.: PCT/IB04/52510

§ 371 Date: May 23, 2006

(30) Foreign Application Priority Data
Nov. 28, 2003 (EP) 03104460.5

(51) Int. Cl. H04N 7/167

(52) U.S. Cl. 380/201

(57) ABSTRACT

The invention relates to a system for re-encoding bitstreams for content signals. A re-encoder (101) receives a bit-stream comprising e.g. an MPEG-2 encoded signal. The receiver (109) feeds the bitstream to an extraction processor (111) which extracts non-essential information from the bitstream thereby generating a reduced bitstream which is still MPEG-2 compliant. The non-essential information, which specifically may be higher frequency transform coefficients, is re-encoded in a re-encode processor (113) using a non-MPEG-2 encoding principle. The encoding may be optimised for the characteristics of the non-essential information resulting in a more efficient encoding. The re-encoded data is inserted in user data section of the reduced bit stream by a combine processor (115). Thus, an effective reduction in the size of the bitstream may be achieved. A decoder (107) may extract the re-encoded data from the user data section, regenerate the original non-essential information and insert this in the reduced bitstream. Specifically, the original bitstream may be regenerated. The approach may specifically be used for reversible bitstream watermarking that which does not increase the size of the bitstream.

### FIELD OF THE INVENTION

The invention relates to a method and apparatus for encoding and/or decoding a bitstream and in particular but not exclusively for encoding and/or decoding of an MPEG (Motion Picture Expert Group) encoded bitstream.

### BACKGROUND OF THE INVENTION

The illicit distribution of copyright material deprives the holder of the copyright the legitimate royalties for this material, and could provide the supplier of this illicitly distributed material with gains that encourages continued illicit distributions. In light of the ease of transfer provided by e.g. the Internet, content material that is intended to be copyright protected, such as artistic renderings or other material having limited distribution rights are susceptible to wide-scale illicit distribution.

In particular, content items such as music or video items are currently attracting a significant amount of unauthorised distribution and copying. This is partly due to the increasing practicality and feasibility of distribution and copying provided by new technologies. For example, the MP3 format for storing and transmitting compressed audio files has made a wide-scale distribution of audio recordings feasible. For instance, a 30 or 40 megabyte digital PCM (Pulse Code Modulation) audio recording of a song can be compressed into a 3 or 4 megabyte MP3 file. Using a typical 56 kbps dial-up connection to the Internet, this MP3 file can be downloaded to a user's computer in a few minutes. This may for example allow a malicious party to provide a direct dial-in service for downloading an MP3 encoded song. The illicit copy of the MP3 encoded song can be subsequently rendered by software or hardware devices or can be decompressed and stored on a recordable CD for playback on a conventional CD player.

A number of techniques have been proposed for limiting the reproduction of copy-protected content material. The Secure Digital Music Initiative (SDMI) and others advocate the use of “digital watermarks” to prevent unauthorised copying.

Digital watermarks can be used for copy protection according to the scenarios mentioned above. However, the use of digital watermarks is not limited to copy prevention but can also be used for so-called forensic tracking, where watermarks are embedded in e.g. files distributed via an Electronic Content Delivery System, and used to track for instance illegally copied content on the Internet. Watermarks can furthermore be used for monitoring broadcast stations (e.g. commercials); or for authentication purposes etc.

Watermarks are frequently embedded in uncompressed signals and several techniques are known therefor. In addition, techniques have been proposed to apply the watermark embedding directly onto the coded bit stream. This technique is frequently referred to as bitstream watermarking. An example thereof is disclosed in United States Patent Application US 2003/00167756 to Steenhof et all.

Bit stream watermarking is generally associated with some disadvantages. For example, a watermark may be embedded by modifying specific bits in a bitstream but this may result in degraded quality of the watermark embedded bitstream as the modification results in loss of information. Alternatively or additionally, watermarks may be introduced by adding information and specifically by adding data bits to an existing bitstream. This will typically result in an increase in the size of the bitstream.

A technique known as reversible watermark embedding has been proposed. This is a technique for embedding data (i.e. the watermark) in a digital signal in such a manner that the original signal can be restored in a bit-exact manner in the restoration process. Thus, no information will be lost due to the watermarking and the quality of the signal represented by the bitstream may be retained.

As an example of a specific reversible watermarking technique, it has been proposed to insert a watermark in a JPEG or MPEG bitstream by multiplying each encoded Discrete Cosine Transform (DCT) coefficient by a factor of two and embedding a watermark in the least significant bit. This allows the original signal to be restored and a watermark to be extracted. However, it inevitably leads to a significant increase in the size of the resulting bitstream. Specifically, the size increase of the MPEG bitstream may even exceed the size of the embedded data This is due to larger levels being encoded with longer code words in MPEG. Thus, embedding I bit may potentially increase the size of the MPEG stream by, for example, 3 bits.

The advancements and increased prevalence of data networks such as the Internet has substantially increased the possibility of distribution and copying of content items with or without the right owner's authorisation. Thus, it has become increasingly difficult for rights owners to safely distribute and control access to content items. Although watermarking has been useful in tracking and monitoring content, the flexibility and opportunities of control are relatively limited. For example, it may be desirable to deliver different versions of the same content item to different categories of users. Watermarking may allow this by different watermarks being embedded in different bitstreams corresponding to the different versions of the content item. However, this requires more than one bitstream to be generated which may increase the complexity of the encoding process as well as the distribution.

Hence, an improved system for encoding bitstreams allowing improved performance and flexibility would be advantageous and in particular an encoding system that would allow increased flexibility, facilitated customisation for different categories of users, reduced bitstream sizes, reduced distribution bandwidth requirements, improved encoding quality and/or improved watermarking would be advantageous.

### SUMMARY OF THE INVENTION

Accordingly, the Invention preferably seeks to mitigate, alleviate or eliminate one or more of the above mentioned disadvantages singly or in any combination.

According to a first aspect of the invention, there is provided a method for re-encoding an input bitstream of an input signal comprising the steps of: receiving the input bitstream; extracting non-essential information from the bitstream to generate a reduced bitstream; re-encoding the non-essential information to generate re-encoded data in accordance with a different encoding rule than used for the non-essential information in the bitstream; and including the re-encoded data in a user data element associated with the reduced bitstream.

The non-essential information may be information which can be removed from the input bitstream while allowing the reduced bitstream to correspond to an encoding of the input signal. Specifically, the format of the reduced input bitstream may be compliant with the original input bitstream. This constraint may allow non-compliant players (e.g. players not suitable for interpreting the re-encoded data) to still present the reduced bitstream The non-essential information is selected in accordance with any suitable algorithm or criterion to suit the requirements of the specific application. Thus, the non-essential information may specifically be a relatively low amount of information resulting in the reduced bitstream being of only slightly reduced quality with respect to the input bitstream or may for example be a significant amount of information resulting in significant and highly perceivable quality degradation. The user data element is a data section, file, bitsream or other data element which is not part of the encoding data of the reduced bitstream.

The input signal may be a content signal such as an audio signal and/or a video signal and the input bitstream may specifically comprise an encoding of the input signal in accordance with a suitable encoding standard. The re-encoding may for example comprise a loss free re-encoding of the non-essential information (or parts thereof) whereby the re-encoded data will retain the fall information of the non-essential information. This will allow a decoder to exactly regenerate the non-essential information which may be combined with the reduced bitstream in a decoder to regenerate an exact copy (apart from differences introduced by errors such as transmission errors). The re-encoding may alternatively or additionally comprise a lossy encoding of the non-essential information (or parts thereof) whereby some of the information of the non-essential information may be lost. However, this may allow a highly efficient re-encoding resulting in a significant bitstream size reduction while incurring only a very small and possibly imperceptible quality reduction.

The steps of the process may be iterated. Thus the reduced bitstream may be used as the input bitstream for a subsequent re-encoding.

The invention may allow an increased flexibility of encoding of an input signal and specifically may allow in increased efficiency, flexibility and differentiation of an encoding of a content signal. Specifically, the embedding of re-encoded data in a user data element may allow compliance with encoding standards not comprising provisions for a flexible and graduated encoding. For example; the invention may allow MPEG encoded bitstreams to be re-encoded as a reduced bitstream and a user data element which together have a smaller size than the original bitstream yet which may allow a decoder to exactly regenerate the original bitstream. Depending in the re-encoding of the non-essential information, the invention may allow, for example, reduced bitstream sizes, embedding of watermarks or additional data without increasing bitstream size and/or differentiation of quality for different users depending on the access rights to the re-encoded data etc.

According to a feature of the invention, the user data element is a user data section of the reduced bit-stream. The user data element may be comprised in a data section of the reduced bit-stream used for non-encoding data For example, if the reduced bitstream is encoded in accordance with the MPEG-2 standard, the user data element may be a user data section as specified in the MPEG-2 standard.

According to another feature of the invention, the user data element is comprised in a separate bit-stream. This feature may for example facilitate distribution of the re-encoded data It may further allow more complex distribution approaches where for example the reduced bitstream is freely distributed whereas the user data element is only distributed to specific recipients. As the re-encoded data is typically of much smaller size than the reduced bitstream, this may significantly facilitate the distribution and will ensure that only the specific recipients can regenerate the original signal.

According to another feature of the invention, the step of extracting non-essential information comprises removing non-essential data corresponding to the non-essential information from the input bitstream. This feature may allow a suitable implementation and may specifically provide a simple yet high performance process for extracting the non-essential information. A resultant bitstream size reduction may be achieved.

According to another feature of the invention, the step of extracting non-essential information comprises modifying quantisation levels of the reduced bitstream. This feature may allow a suitable implementation and may specifically provide a simple yet high performance process for extracting the non-essential information According to another feature of the invention, the step of re-encoding comprises a compression of the non-essential information. Specifically, the non-essential information may be re-encoded to require fewer bits than used for the representation of the non-essential information in the input bitstream. This may allow a combined size of the reduced bitstream and the re-encoded data to be less than the bitstream size of the input bitstream.

According to another feature of the invention, the non-essential information corresponds to less significant data values associated with the input signal. The less significant data values may for example be least significant bits of data values, higher frequency encoding coefficients or low value data values. Hence, the less significant data values may be values which can be removed from the input bitstream with only a minor effect on the perceived quality of the encoded signal. The feature may provide a suitable criterion for identifying suitable non-essential information which may be extracted.

According to another feature of the invention, the method further comprises the step of determining the non-essential information in response to a perceptual model associated with the input signal. This allows for the extraction of non-essential information to be suited for the desired effect on the perceived quality of the encoded signal. Thus, in some embodiments, the non-essential information may be selected to achieve a desired high quality degradation (for example the removal of colour information) which can only be remedied by use of the re-encoded data. In other examples, the non-essential information may be selected to achieve low perceived (or not perceivable) quality degradation such as for example when embedding a watermark in a bitstream.

According to another feature of the invention, the method further comprises the step of including an indication in the user data element of the presence of re-encoded data in the user data element. This provides for a simple, easy to implement and practical way of communicating to recipients of the user data element and the reduced bitstream that further re-encoded data is available.

According to another feature of the invention, the method further comprises the step of including additional data in the user data element This feature may allow additional information to be conveyed to receivers of the user data element The additional data may relate to the input signal or the reduced bitstream but is not limited to this and may for example relate to user subscription information, version information, source information etc. Hence, a number of additional functions, enhancements and services may be enabled. As the re-encoding may allow a reduction in the bitstream size, the additional data may possibly be included without resulting in an increased amount of data and thus distribution requirements may not increase.

According to another feature of the invention, the additional data comprises a watermark. Thus, the invention may allow a method of embedding a watermark in a bitstream where the re-encoding of the non-essential information preferably compensates for the additional data being embedded, and which preferably allows the original bitstream to be precisely regenerated. Thus bitstream watermark embedding with no quality degradation or increase in bitstream size may be provided.

According to another feature of the invention, the method as claimed further comprises the step of encrypting at least part of the additional data. This feature may allow restricted access to the additional data and may thus allow features and functionality associated therewith to be controlled and limited.

According to another feature of the invention, the additional data comprises data selected from the group consisting of: revocation data; Digital Rights Management (DRM) information data; and checksum data These data elements allow services that are particularly advantageous for the distribution and management of encoded signals and particularly enables or facilitates suitable services for distribution and access control for content signals in large networks such as the Internet.

According to another feature of the invention, the step of re-encoding the non-essential information comprises encryption. This may allow access to the re-encoded data to be restricted thereby allowing a substantially improved flexibility and performance in management of access to content items. For example, a single bitstream comprising the reduced bitstream and the user data element may be freely distributed. All receivers may present the encoded content item at a reduced quality based only on the reduced bitstream (a preview). However, the full quality representation is limited to receivers having access rights to the re-encoded data Specifically, the re-encoding of the non-essential information may comprise or consist in encrypting extracted non-essential data values from the input bitstream. These data values may accordingly only be re-inserted in the reduced bitstream by units having the appropriate decryption key(s). Thus, access to content may be controlled simply by a secure distribution of decryption keys.

Preferably the input bitstream is an MPEG encoded bitstream of the input signal. The MPEG encoding standard may specifically be for a video input signal and/or an audio input signal.

According to another feature of the invention, the non-essential information corresponds to higher frequency transform coefficients. Typically, higher frequency coefficients of the DCT of MPEG encoding comprise less perceptual information than lower frequency coefficients. Hence, a quality reduction associated with extraction of non-essential information may be reduced.

According to another feature of the invention, the step of extracting comprises extracting run-level pairs of the bitstream. This provides for a suitable, simple and high performance implementation.

According to another feature of the invention at least some of the run-level pairs are the run-level pairs immediately prior to an end of block indication. This allows a particularly suitable and easy to implement implementation.

According to another feature of the invention, the step of re-encoding the non-essential pairs comprise re-encoding the run-level pairs using a different run length value to data word association than specified for MPEG. Specifically, a run length value to data word association may be used which is particularly suitable for the characteristics of the run length pairs that are extracted. Thus a more efficient encoding of these run length pairs may be achieved resulting in an overall data reduction.

According to another feature of the invention, the reduced bitstream and the input bitstream are both in accordance with the same encoding standard. For example, both the input bitstream and the reduced bitstream may be MPEG encoded bitstreams. Preferably, non-essential information is extracted from the MPEG encoded bitstream by removing data values such that the remaining bitstream is still a valid MPEG encoded bitstream albeit at a reduced quality.

Preferably the combined data rate of the re-encoded data and the reduced bitstream is equal to or less than a data rate of the input bitstream.

According to a second aspect of the invention, there is provided a method for decoding an input bitstream for an input signal comprising the steps of: receiving the input bitstream, the input bitstream comprising a reduced bitstream for the input signal; receiving a user data element comprising encoded data associated with the input signal; extracting the encoded data from the user data element; re-encoding the encoded data to generate enhancement data compatible with an encoding of the input signal in the reduced bitstream; and generating a output bitstream by combining the reduced bitstream and the enhancement data.

According to a third aspect of the invention, there is provided an apparatus for re-encoding an input bitstream of an input signal, the apparatus comprising: means for receiving the input bitstream; means for extracting non-essential information from the bitstream to generate a reduced bitstream; means for re-encoding the non-essential information to generate re-encoded data in accordance with a different encoding rule than used for the non-essential information in the bitstream; and means for including the re-encoded data in a user data element associated with the reduced bitstream.

According to a fourth aspect of the invention, there is provided an apparatus for decoding an input bitstream for an input signal, the apparatus comprising: means for receiving the input bitstream, the input bitstream comprising a reduced bitstream for the input signal; means for receiving a user data element comprising encoded data associated with the input signal; means for extracting the encoded data from the user data element; means for re-encoding the encoded data to generate enhancement data compatible with an encoding of the input signal in the reduced bitstream; and means for generating an output bitstream by combining the reduced bitstream and the enhancement data.

According to a fifth aspect of the invention, there is provided a bitstream comprising a reduced bitstream section corresponding to an encoding of a content signal and a user data section comprising encoded data for the input signal encoded in a different format than an encoding format for the reduced bitstream section.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 illustrates a block diagram of a bitstream distribution system in accordance with an embodiment of the invention;

FIG. 2 illustrates an example of a table for variable length coding of run-level pairs in accordance with the MPEG-2 encoding standard; and

FIG. 3 illustrates a table for encoding of run-level pairs in accordance with an embodiment of the invention.

### DESCRIPTION OF PREFERRED EMBODIMENTS

The following description focuses on an embodiment of the invention applicable to MPEG-2 encoded bitstreams of video content signals but it will be appreciated that the invention is not limited to this application but may be applied to many other encoded bitstreams and signals.

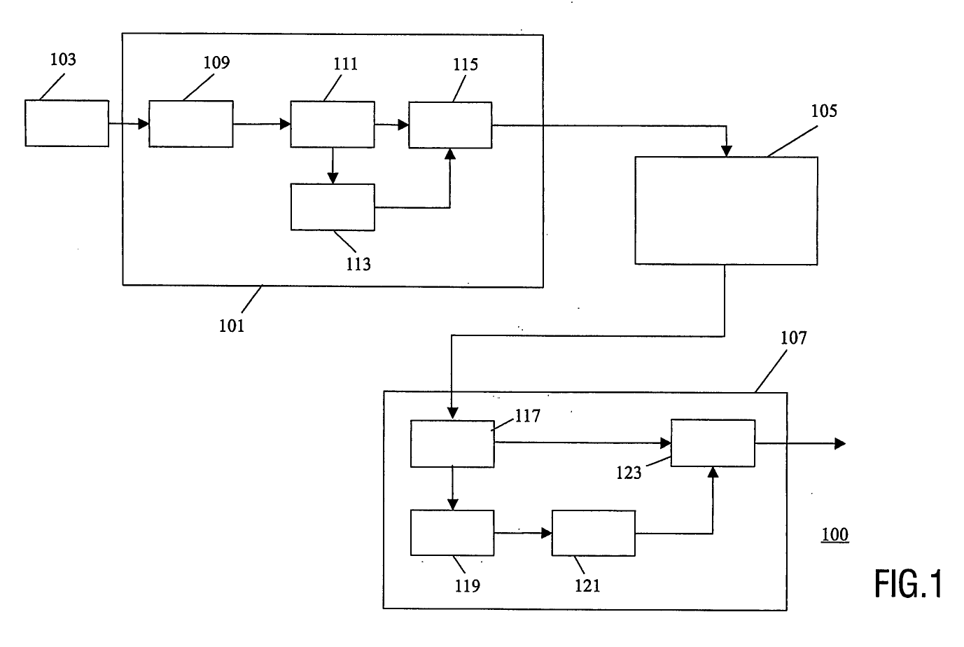

FIG. 1 illustrates a block diagram of a bitstream distribution system 100 in accordance with an embodiment of the invention.

The bitstream distribution system 100 comprises a re-encoder 101 which is coupled to a bitstream source 103. The bitstream source 103 generates a bitstream by encoding a content signal, and specifically in the described embodiment, the bitstream source 103 generates an MPEG-2 encoded bitstream by encoding a content video signal. The bitstream source 103 feeds the encoded bitstream to the re-encoder 101. It will be appreciated that in other embodiments, the bitstream source 103 may be comprised in the re-encoder 101. It will further be appreciated that the bitstream source 103 may be any suitable means for providing an encoded bitstream to the re-encoder 101 and does not need to comprise functionality for performing the encoding itself. For example, the bitstream source 103 may be a network coupled to a plurality of external sources.

The re-encoder 101 is coupled to a network 105 which may distribute an output bitstream from the re-encoder 101 to other network elements. Specifically, the network 105 may be the Internet It will be appreciated that the bitstream source 103 may be part of the network 105.

The bitstream distribution system 100 further comprises a decoder 107 which is also coupled to the network 105. Thus the output bitstream of the re-encoder 101 may be distributed to the decoder 107 by the network. The decoder 107 may decode the received bitstream to generate a video signal that may be presented to a user on a suitable display (not shown). Additionally or alternatively, the decoder may decode a received bitstream to generate a modified bitstream.

The re-encoder 101 comprises a receiver 109 which is operable to receive the input bitstream from the bitstream source 103. Specifically, the receiver 109 may be a network interface.

The receiver 109 is coupled to an extraction processor 111 which is operable to extract non-essential information from the bitstream. Specifically, the extraction processor 111 may remove encoding information from the bitstream such that a reduced bitstream is generated having a reduced quality due to the removal of encoding information. It will be appreciated that any suitable method, criterion or algorithm for determining and extracting non-essential information may be used. It will also be appreciated that preferably not all non-essential information is removed but only the information required in order to achieve the desired effect for the specific application is removed.

In the described embodiment, non-essential information is extracted by removing specific non-essential data from the input bitstream and in particular data is removed such that the resulting reduced bitstream is still a valid MPEG encoded bitstream of the original signal albeit at a degraded quality. Hence, in the described embodiment non-essential information is considered to be information which may be removed while allowing the resulting reduced bitstream to still be a valid encoded representation of the original signal. In the specific embodiment, the reduced bitstream obtained by removing non-essential data is still a valid MPEG-2 encoded bitstream that may be decoded by standard MPEG-2 decoders.

The extraction processor 11 is coupled to a re-encode processor 113 which is operable to receive the extracted non-essential information from the extraction processor 111 and to re-encode the non-essential information to generate re-encoded data. The encoding rules used for the re-encoding of the non-essential information are different than the encoding rules that were used for the encoding of this information in the input bitstream. Specifically, for the described embodiment, the re-encoding may be incompatible with MPEG-2.

Thus, the re-encoding of the non-essential information in the re-encode processor 113 is not limited to the encoding standard but may be selected to specifically meet the desires and requirements of the specific application as well as be optimised for the specific characteristics of the non-essential information. For example, the non-essential information will typically be selected to have different characteristics than the remaining part of the input bit stream. For example, the non-essential information may tend to have relatively low data values. Thus, the re-encoding may be optimised for encoding of low data values thereby resulting in a more efficient encoding. This may enable a reduction in the number of bits required for representing the non-essential information. In the specific embodiment, the re-encoding of the non-essential information is loss free, i.e. the non-essential information may be exactly regenerated from the re-encoded data.

The re-encoder 101 further comprises a combine processor 115 which is coupled to the extraction processor 111 and the re-encode processor 113. The combine processor 115 receives the reduced bitstream from the extraction processor 111 and the re-encoded data from the re-encode processor 113. In the described embodiment, the combine processor 115 is operable to include the re-encoded data in a user data element associated with the reduced bitstream. The combine processor 115 is coupled to the network 105 and is operable to distribute the user data element and the reduced bitstream to other network elements.

The distribution of the user data element and the reduced bitstream may be a combined distribution where they are distributed together or may be a an individual distribution where for example the reduced bitstream is freely distributed whereas the user data element is only distributed to selected network elements or users.

In the specific described embodiment, the reduced bitstream and the user data element are combined to generate a single bitstream. Specifically, the re-encoded data is included in a user data section of the MPEG-2 encoded reduced bitstream. Thus, the user data element may specifically be a user data section of the reduced bitstream.

It will be appreciated that the extraction and re-encoding of the non-essential information allows for increased flexibility as the re-encoding of the non-essential information can be optimised for the characteristics of the non-essential information and the specific application. This, re-encoding is not limited by having to comply with the encoding standard of the input bitstream. For example, the re-encoding may be optimised to result in a more efficient compression and a reduced size of the combined bitstream. At the same time, the combined bitstream is in the described embodiment encoded in accordance with the MPEG-2 standard and an MPEG-2 decoding may thus be performed by a standard MPEG-2 decoder based on the reduced bitstream. Thus a standard decoder may still generate a valid visual signal albeit at a reduced quality due to the extraction of the non-essential information.

Furthermore, the re-encoded data allows a decoder operable to use this data to improve the quality of the signal of the reduced bitstream. FIG. 1 illustrates the principle of a decoder 107 that may achieve this.

In the described embodiment, the decoder 107 receives the combined bitstream from the re-encoder 101 through the network 105. Thus, the decoder 107 comprises a decoder receiver 117 which is operable to receive the combined bitstream and thus to receive both the reduced bitstream and the user data element comprising further encoding data. It will be appreciated that in other embodiments, the reduced bitstream and the user data element may be distributed and received separately.

The decoder receiver 117 is coupled to a user data element processor 119 which is fed the received user data element. The user data element processor 119 is operable to extract the encoded data from the user data element. It will be appreciated that in some embodiments, the user data element processor 119 may be part of the decoder receiver 117 and may specifically be operable to extract the user data element and the reduced bitstream from a combined stream. Specifically, the user data element processor 119 may process a received MPEG-2 compliant bitstream and extract the data of all user data sections.

The user data element processor 119 is coupled to a re-encoding unit 121 which is operable to re-encode the encoded data to generate enhancement data compatible with an encoding of the input signal in the reduced bitstream. In the described embodiment the re-encoding unit 121 specifically regenerates the non-essential information extracted by the re-encoder 101 from the encoded data. Thus, in this embodiment the enhancement data corresponds to the non-essential information removed from the reduced bitstream. In the described embodiment where the re-encoding of the re-encode processor 113 in the re-encoder 101 is loss free, the enhancement data may correspond exactly to the original non-essential information.

The decoder 107 further comprises a bitstream generator 123 which is coupled to the decoder receiver 117 and to the re-encoding unit 121. The bitstream generator 123 is operable to generate an output bitstream by combining the reduced bitstream and the enhancement data. Specifically, in the described embodiment where the extraction processor 111 simply removes data values from the input bitstream, the bitstream generator 123 may create the output bitstream by inserting the enhancement data into the appropriate locations of the reduced bitstream thereby generating an output bitstream corresponding to the original bitstream of the bitstream source 103. It will be appreciated that in the absence of processing and communication errors, the original bitstream may be exactly generated at the decoder 107.

The decoder 107 may thus generate a modified bitstream. In some embodiments, the decoder may furthermore regenerate the encoded video signal and present this to a user.

The bitstream distribution system 100 of FIG. 1 may thus provide a system wherein an input bitstream may be more flexibly and efficiently encoded. Specifically, this may reduce the bitstream size and/or allow additional data to be included in the bitstream. The system may further allow an introduced quality degradation to be compensated in a suitable decoder and specifically if loss free encoding is used in the re-encoder, the original bitstream may be regenerated exactly.

The system may furthermore provide for a flexible and graduated distribution of content where a bitstream may be decoded at a given quality level in standard decoders and at a higher quality level in decoders having access to and functionality for processing the re-encoded data of the user data element. Thus, the system may provide for increased flexibility and functionality for managing and controlling access to content signals.

A specific embodiment directed to reversible embedding of a watermark in an MPEG-2-bitstream will be described in more detail in the following with specific reference to the bitstream distribution system 100 of FIG. 1.

The embodiment will be described with specific reference to the encoding of DCT (Discrete Cosine Transform) coefficients in a so-called intraframe which is a frame that is independently compressed.

Compression of an intraframe comprises segmentation of the frame into 8×8 pixel element blocks. A two-dimensional DCT transformation is performed on the 8×8 blocks resulting in 8×8 blocks of DCT coefficients. The DCT coefficients contain information on the horizontal and vertical spatial frequencies of the input block. The coefficient corresponding to zero horizontal and zero vertical frequency is called the DC coefficient Typically for natural images, the distribution of these coefficients is not uniform; the transformation tends to concentrate the energy into the low-frequency coefficients.

The DCT coefficients are quantized using selected quantization levels. The degree of quantization applied to each coefficient is dictated by the impact of the perceptual distortion. In practice, this means that the high-frequency coefficients are more coarsely quantized than the low-frequency coefficients. Information of the selected quantization levels is encoded in the MPEG bitstream.

The DCT coefficients are then ordered into a one dimensional sequence, i.e. the two-dimensional 8×8 block of DCT coefficients is mapped to a one-dimensional array of 64 coefficients. Specifically, the mapping for MPEG corresponds to a zigzag path through the 8×8 block of DCT coefficients. Thus, the one-dimensional array generally has frequencies arranged in order of the two-dimensional spatial frequencies. The mapping of the quantized DCT coefficients exploits the likely clustering of energy into the low-frequency coefficients.

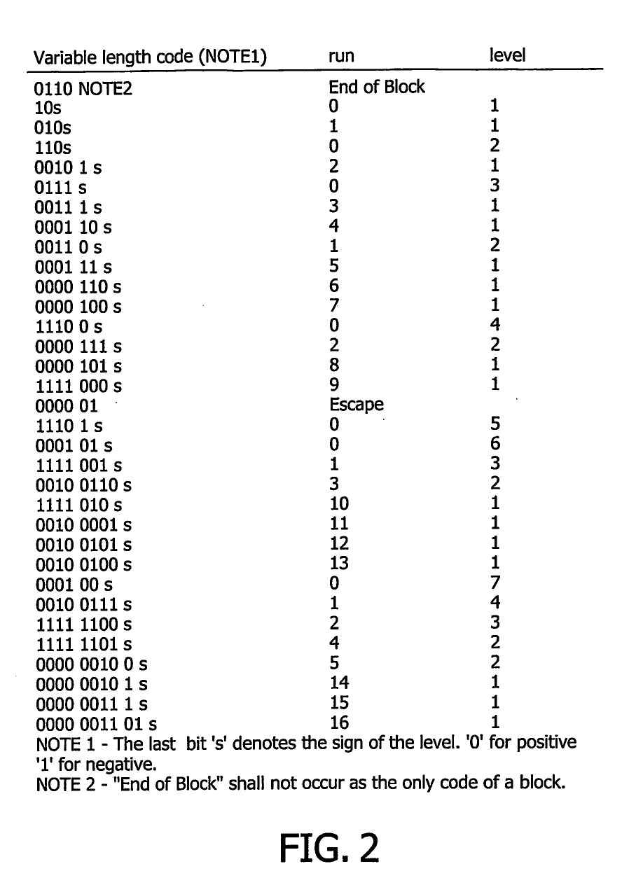

The DCT coefficients of the one dimensional array are then entropy coded using a variable-length code (VLC). In this step, the actual compression takes place. The VLC uses a fixed table for converting VLC run-level pairs into specific bit sequences. An example of a table used for MPEG is illustrated in FIG. 2. Thus, each VLC codeword denotes a run of zeros (i.e., the number of zero valued DCT coefficients preceding a non-zero DCT coefficient) followed by the non-zero coefficient of a particular level. VLC coding recognizes that short runs of zeros are more likely than long ones, and small coefficients are more likely than large ones. It allocates code words of different lengths for the various VLC codes that occur.

To illustrate the variable-length coding process in more detail, consider the following sequence of DCT coefficients
−7,6,5,0,0,0, −2, −1, 0,1,0, . . . , 0.

Following the VLC coding approach, this sequence is mapped to the following run-level pairs:
(0,−7), (0,6), (0,5), (3,−2), (0,−1), (1,1), EOB

In this notation, the first number of a pair indicates the number of zeros preceding the value of the second number. The final run of zeros is replaced with an end of block (EOB) marker. Using the table of FIG. 2, these run-level pairs are converted to a bit stream. In the specific example the run-levels would be converted to the following code:
0001001/0001010/111010/001001101/101/0100/0110/EOB.

In the specific embodiment, the extraction processor 111 will receive the MPEG bitstream encoded as described above. It will be able to extract non-essential information and specifically will remove data from the encoded bitstream in the form of code words for specific run-level pairs. As mentioned previously, high frequency DCT coefficients tend to be of lower magnitude and to have a relatively low impact on the perceived quality of the signal. In the current embodiment, higher frequency transform coefficients are removed from the received bitstream and specifically the code words for the last run-level pairs before End Of Block indications are removed from the bitstream. Thus, in the specific example above the code word 0110 corresponding to the run-level pair (1,1) is removed from the bitstream. Accordingly, a reduced bitstream is generated which has less high frequency information than the original bitstream. However, the bitstream has a reduced size and the quality degradation will typically be relatively low.

It should be noted that-any suitable run-level pair could be removed provided that the stream is still a valid MPEG stream. However coefficients corresponding to high-frequencies are preferable as this yields the least perceptual distortion.

The removed run-level pairs (the run-level pair (1,1) in this example) are fed to the re-encode processor 113 where they are re-encoded using a different encoding approach than the MPEG-2 standard VLC of FIG. 2.

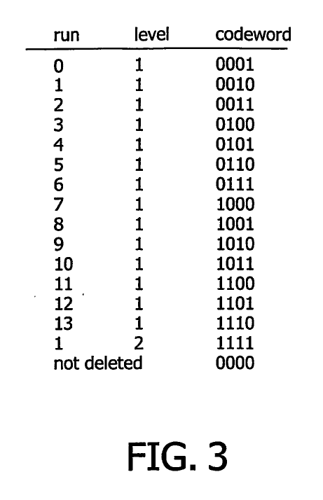

Specifically, the re-encoding may use a VLC based on a different run-level pair to code word association than that used for MPEG-2. For example, the characteristics and statistics of coefficients corresponding to high-frequencies are different than the characteristics and statistics associated with all the coefficients. For example, an experimental evaluation of the last run-level pairs in an 8×8 block for various video sequences demonstrated that about 90% of these run-level pairs have a level of 1 and a run between 0 and 13. Thus, taking this into account, a more efficient association between run-level pairs and code words may be generated. FIG. 3 illustrates a table for encoding of run-level pairs which may be suitable for re-encoding the removed run-level pairs. Comparison of FIGS. 2 and 3 shows that a number of frequently occurring run-level pairs may be represented by significantly fewer bits. Specifically, all run-level pairs of FIG. 3 are presented by four bits whereas the same run-level pairs of FIG. 2 are encoded in code words of up to eight bits. Hence, the reduced bitstream together with the re-encoded data from the re-encode processor 113 will have a total size which typically is less than that of the original bitstream.

Furthermore, no information has been lost and a suitable decoder may regenerate the original bitstream exactly.

It will be appreciated that other approaches to the re-encoding may be used.

For example, instead of using a fixed table for the VLC translation, an adaptive table based on the statistics of the image(s) may be used.

In the specific embodiment, the re-encoded run-level pairs are re-inserted in the reduced bitstream by the combine processor 115. The re-encoded run-level pairs are specifically inserted in user data sections of the MPEG-2 bitstream. Accordingly, a conventional decoder will ignore the re-encoded run-level pairs and decode the signal based on the reduced bitstream. Thus, a signal may still be generated albeit at reduced quality.

However, an enhanced decoder may be operable to extract the re-encoded code words from the user data section. The decoder may then regenerate the run-level pairs from the re-encoded code words and consequently re-encode these according to the MPEG-2 standard (i.e. using the table of FIG. 2). The resulting run-level pair code words are identical to the ones removed by the extraction processor 111 and may consequently be inserted in the reduced bitstream to regenerate the original bitstream. Thus, a bitstream size reduction may be achieved with no loss of quality.

The re-encoder 101 may further be operable to include further data in the user data section. Specifically, the re-encoder 101 may insert a watermark in the user data section. Thus, a reversible bitstream watermarking system is provided wherein a watermark may be embedded in a bitstream. In a standard decoder, the embedding of the watermark may result in a slight quality degradation but for a decoder compatible with the described approach, the watermark may be detected and the original bitstream may be precisely regenerated.

Furthermore, this may be achieved without any increase in the size of the bitstream. It should be noted that the extraction of non-essential information does not necessarily require that specific data of the input bitstream is removed. Rather the non essential information may for example be extracted by modifying data values through a modification of the encoding parameters used. For example, the quantisation level of some or all coefficients may be changed. This may result in a coarser quantisation and thus in loss of non-essential information and thus a reduced bitstream. Information related to the finer quantisation levels may be encoded and stored in the user data element for retrieval by a decoder.

In some embodiments, the user data element may further include an indication of the presence of the re-encoded data in the user data element. For example, a simple flag may be set to indicate that the re-encoded data is included. Thus, a decoder may check all incoming bitstreams for the presence of this flag in the user data section. If a flag is not detected it proceeds to perform a standard decoding and if a flag is detected, it proceeds to generate the enhancement data and include it with the bitstream.

It will be appreciated that any suitable method for determining and selecting the non-essential information may be used. For example, the non-essential information may be determined in response to a perceptual model associated with the input signal. Thus, the non-essential information to be removed may be specifically selected to achieve a desired impact on the perceivable quality of the bitstream.

It will also be appreciated that any suitable method or rule for re-encoding the non-essential information may be used. For example, the re-encoding may be loss-free allowing an accurate and exact regeneration of the original bitstream. However, the re-encoding may also be a lossy re-encoding wherein information is lost. This may provide-for a highly efficient encoding and may result in an increased reduction in the size of the bitstream.

It will furthermore be appreciated that the described steps may be iterated as suitable. For example, following the removal and re-encoding of the last run-level pairs, before the End Of Block indicators, the same process may be applied to the reduced bitstream thus extracting and re-encoding the last run-level pairs before End Of Block indicators in the reduced bitstream.

In some embodiments the re-encoding of the non-essential information may comprise or consist in encryption of data representing the non-essential information. Thus, the re-encoded data comprised in the user data element may be encrypted and thus only be accessible to users or decoders having access to the decryption key. In these embodiments, the non-essential information may be extracted to degrade the quality of the bitstream to a given quality level. For example, the extraction processor 111 may be operable to extract all colour information from the bitstream resulting in the reduced bitstream comprising a black and white signal only. The colour information may be encrypted and comprised in the user data section of the reduced bitstream. Thus, a decoder receiving the bitstream from the re-encoder 101 may be able to generate a black and white signal. However, the full colour signal can only be generated if the decoder comprises functionality for utilising the data of the user data element and if it has the required decryption key.

This may allow a graduated and sophisticated distribution and access control for content items. For example, a bitstream comprising the reduced bitstream and encrypted re-encoded data may be freely distributed e.g. on the Internet. This will allow a reduced quality preview of the content item. A given user may contact the content provider to obtain a suitable encryption key in return for a payment. Thus, the access to content may be controlled by the encryption and distribution of encryption keys rather than by controlling the distribution of the content item itself.

It will be appreciated that any suitable encryption and decryption algorithm may be used. It will further be appreciated that any suitable decryption key distribution, control or management process may be applied.

It will be appreciated that the re-encoding in these embodiments preferably, but not necessarily, comprises both encryption and data compression. This may specifically allow that a combined preview/full quality content item may be generated without an increased bitstream size.

In some embodiments, both additional data and the re-encoded data comprised in the user data section are encrypted. Thus, only a compliant device having the appropriate decryption key can access the additional data. The additional data may specifically include one or more of the following:

Revocation information. Revocation information may be used to switch off devices for which particular secrets (e.g device encryption keys) are leaked so that content may be copied in a relatively easy manner. When a device is revoked, it is no longer able to present particular compliant content.

Digital Rights Management information. This relates to information related to the rights to perform actions related to the digital content. Examples of rights are ‘play once’, ‘copy once’, ‘copy never’, etc

Robust checksum. This relates to data which can be used to verify the correct operation of the signal transformation.

Other examples of additional data that may be included include audio enhancement data, audio encoding information (e.g. OCS Optimal Coding for Stereo data), video enhancement data, data to support conversion from 2D to 3D video, etc.

The embodiments may thus provide the advantage of the bitstream from the re-encoder being backwards compatible (i.e. legacy devices may be used for playback of e.g. watermarked or encrypted streams). Moreover, information in the user data element may be made cryptographically secure. Although, removing this data may be relatively easy, it will always be at the cost of degraded quality. The amount of such degradation can be adjusted by the producer or content provider for specific applications, i.e. the signal quality is scalable. It is further an advantage that the encryption may be achieved without an increase in the size of the bitstream.

It will be appreciated that while the above description has focussed on including the user data element in the reduced bitstream, the user data element may be stored and distributed in any suitable way including being distributed in a separate file or bitstream.

The invention can be implemented in any suitable form including hardware, software, firmware or any combination of these. However, preferably, the invention is implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A method for encoding an input bitstream of an input signal comprising the steps of:
receiving the input bitstream;
extracting non-essential information from the input bitstream to generate a reduced bitstream;
re-encoding the non-essential information to generate re-encoded data in accordance with a different encoding rule than used for the non-essential information in the bitstream; and
including the re-encoded data in a user data element associated with the reduced bitstream.

2. A method as claimed in claim 1 wherein the user data element is a user data section of the reduced bit-stream.

3. A method as claimed in claim 1 wherein the user data element is comprised in a separate bit-stream.

4. A method as claimed in claim 1 wherein the step of extracting non-essential information comprises removing non-essential data corresponding to the non-essential information from the input bitstream.

5. A method as claimed in claim 1 wherein the step of extracting non-essential information comprises modifying quantisation levels of the reduced bitstream.

6. A method as claimed in claim 1 wherein the step of re-encoding comprises a compression of the non-essential information.

7. A method as claimed in claim 1 wherein the non-essential information corresponds to less significant data values associated with the input signal.

8. A method as claimed in claim 1 further comprising the step of determining the non-essential information in response to a perceptual model associated with the input signal.

9. A method as claimed in claim 1 further comprising the step of including an indication in the user data element of the presence of re-encoded data in the user data element.

10. A method as claimed in claim 1 further comprising the step of including additional data in the user data element.

11. A method as claimed in claim 10 wherein the additional data comprises a watermark.

12. A method as claimed in claim 10 further comprising the step of encrypting at least part of the additional data.

13. A method as claimed in claim 10 wherein the additional data comprises data selected from the group consisting of:
a revocation data;
b. digital rights management information data; and
c. checksum data

14. A method as claimed in claim 1 wherein the step of re-encoding the non-essential information comprises encryption.

15. A method as claimed in claim 1 wherein the input bitstream is an MPEG encoded bitstream of the input signal.

16. A method as claimed in claim 15 wherein the non-essential information corresponds to higher frequency transform coefficients.

17. A method as claimed in claim 15 wherein the step of extracting comprises extracting run-level pairs of the bitstream.

18. A method as claimed in claim 17 wherein at least some of the run-level pairs are the run-level pairs immediately prior to an end of block indication.

19. A method as claimed in claim 17 wherein the step of re-encoding the non-essential pairs comprises re-encoding the run-level pairs using a different run length value to data word association than specified for MPEG.

20. A method as claimed in claim 1 wherein the reduced bitstream and the input bitstream are both in accordance with the same encoding standard.

21. A method as claimed in claim 1 wherein a combined data rate of the re-encoded data and the reduced bitstream is equal or less than a data rate of the input bitstream.

22. A computer program enabling the carrying out of a method according to claim

23. A record carrier comprising a computer program as claimed in claim 22.

24. A method for decoding an input bitstream for an input signal comprising the steps of:
receiving the input bitstream, the input bitstream comprising a reduced bitstream for the input signal;
receiving a user data element comprising encoded data associated with the input signal;
extracting the encoded data from the user data element;
re-encoding the encoded data to generate enhancement data compatible with an encoding of the input signal in the reduced bitstream; and
generating an output bitstream by combining the reduced bitstream and the enhancement data.

25. A method as claimed in claim 24 wherein the encoded data of the user section is encoded in a format which is incompatible with an encoding format of the reduced bitstream.

26. A method as claimed in claim 24 wherein the encoded data is encrypted and the step of re-encoding comprises decrypting the encoded data.

27. A method as claimed in claim 24 wherein the input bitseam comprises an MPEG encoding of the input signal.

28. A method as claimed in claim 24 further comprising the step of extracting additional data from the user data element.

29. A method as claimed in claim 24 wherein the additional data is a watermark.

30. A method as claimed in claim 24 wherein the user data element is a user data section of the input bitstream.

31. A computer program enabling the carrying out of a method according to claim 24.

32. A record carrier comprising a computer program as claimed in claim 28.

33. An apparatus (101) for encoding an input bitstream of an input signal, the apparatus (101) comprising:
means (109) for receiving the input bitstream;
means (111) for extracting non-essential information from the bitstream to generate a reduced bitstream;
means (113) for re-encoding the non-essential information to generate re-encoded data in accordance with a different encoding rule than used for the non-essential information in the bitstream; and
means (115) for including the re-encoded data in a user data element associated with the reduced bitstream.

34. A apparatus (107) for decoding an input bitstream for an input signal, the apparatus (107) comprising:
means (117) for receiving the input bitstream, the input bitstream comprising a reduced bitstream associated with the input signal;
means (117) for receiving a user data element comprising encoded data for the input signal;

5 means ( 19) for extracting the encoded data from the user data element;
means (121) for re-encoding the encoded data to generate enhancement data compatible with an encoding of the input signal in the reduced bitstream; and
means (123) for generating an output bitstream by combining the reduced bitstream and the enhancement data

35. A bitstream comprising a reduced bitstream section corresponding to an encoding of a content signal and a user data section comprising encoded data for the input signal encoded in a different format than an encoding format of the reduced bitstream section.
